(19) United States
(12) Patent Application Publication
(10) Pub. No.: US 2014/0079256 A1
(43) Pub. Date: Mar. 20, 2014

(54) ONE-PIECE ACTIVE ACOUSTIC LOUDSPEAKER ENCLOSURE CONFIGURABLE TO BE USED ALONE OR AS A PAIR, WITH REINFORCEMENT OF THE STERO IMAGE

(71) Applicant: Parrot, Paris (FR)

(72) Inventors: Julien De Muynke, Paris (FR); Benoit Pochon, Paris (FR); Thomas Dromer, Paris (FR)

(73) Assignee: Parrot, Paris (FR)

(21) Appl. No.: 13/960,664

(22) Filed: Aug. 6, 2013

(30) Foreign Application Priority Data
Sep. 18, 2012 (FR) 1258755

(51) Int. Cl. H04R 5/02

(52) U.S. Cl. CPC H04R 5/02
USPC 381/300

(57) ABSTRACT

The loudspeaker enclosure (10) comprises a central channel (16) turned toward the listener, and left and right side channels (18L, 18R) oriented perpendicular to each other. The signal to be reproduced is separated into: i) a mono component correlated between the left and right signals; ii) left and right surround components decorrelated between the left and right signals; iii) a left component decorrelated between the mono component ant the left signal; and iv) a right component decorrelated between the mono component ant the right signal. The central channel and the side channels are piloted by combinations of these components according to a distribution that is a function of the mode of use of the loudspeaker enclosure, alone in front of a listener and as a pair in association with another similar loudspeaker enclosure, the two loudspeaker enclosures being arranged on the left and on the right of the listener. The directivity diagram is thus modified to create therein directions of cancellation of the stereo image without deformation of the signal rendered.

The invention relates to the reproduction of audio signals by a high-fidelity equipment, with rendering and reinforcement of the stereo effect in front of a listener.

Traditionally, the ideal configuration for stereo listening consists in placing two loudspeaker enclosures remote from each other, forming an isosceles triangle with the listener. In this configuration, a stereo image is formed between the two loudspeaker enclosures, i.e. various sources (for example, different instruments) will appear, distributed along the axis connecting the two loudspeaker enclosures.

Furthermore, it is desirable that the acoustic environment of the loudspeaker enclosures is empty or absorbent in order to avoid the spurious reflections on the walls of the room, which then form new sources. In any case, it may be desired that the environment is symmetrical, which would allow at least not to unbalance the stereo image.

A first problem lies in obtaining such an effect with a single loudspeaker enclosure placed in front the listener.

Such a loudspeaker enclosure is shown, for example, in the article of Jacob Schulman entitled “Parrot Zikmu Solo Wireless Speaker by Philippe Starck Hands-on”, published on Jan. 10, 2012, on www.theverge.com, XP055064354, XP055064341 and XP055064344. Many configurations have been still proposed, which group together, in a same loudspeaker enclosure, a plurality of acoustic transducers, for example in the U.S. Pat. No. 3,892,624 A, U.S. Pat. No. 6,169,812 B1 and U.S. Pat. No. 7,412,380 B1, as well as the article of Christof Faller entitled “Multiple-Loudspeaker Playback of Stereo Signals”, published in the Journal of Audio Engineering Society, Vol. 54, N° 11, November 2006.

It is in particular possible to place loudspeakers on the sides of the loudspeaker enclosure, so that they radiate toward the walls. The loudspeakers being directive, especially in the high-pitch range, accuracy will however by lost in the mono component, which then cannot be rendered accurately in the front direction of the loudspeaker enclosure. If a means for filtering the signals (digital processing of the signals before their amplification and application to the loudspeakers) is available, it may be conceived to apply a system of the binaural rendering type, based on psycho-acoustic properties of the human ear. Such technique is a technique of cross-talk cancellation and filtering by the binaural responses, which allows placing virtually the loudspeakers at arbitrary positions in the room. The difficulty lies in that these responses will be also applied to the mono component, which will deform the latter. Moreover, this solution requires an accurate positioning of the listener with respect to the loudspeaker enclosure.

Moreover, the systems using a single loudspeaker enclosure are all the more difficult to implement that the “shape factor” of the loudspeaker enclosure is narrow, because the loudspeakers placed on the sides cannot be more spaced apart than the width of the loudspeaker enclosure. Now, it is desirable that aesthetically-elegant and easy-to-accommodate products can be proposed, which implies making loudspeaker enclosures in the form of extremely narrow columns.

Finally, a single one-piece loudspeaker enclosure is liable to be placed on a side of the room and not in the middle of a wall, which may unbalance its acoustic environment, dashing the effects of the processing operations for rendering an homogeneous stereo image.

One of the objects of the invention is to compensate for these various limitations, by proposing a compact, multi-channel one-piece loudspeaker enclosure, which is capable of rendering optimally the stereo image, without notable deformation of the acoustic signal, and this in a parameterizable manner so as to be able, if need be, to adapt to various configurations of listening room.

Another object of the invention is to propose a new type of one-piece active loudspeaker enclosure, which may be used flexibly in two possible configurations:
either alone, with a single loudspeaker enclosure placed in front of a listener (hereinafter “solo mode”) in the listening room,
or as a pair, with two similar loudspeaker enclosures arranged on the left and on the right, respectively, of the listener (hereinafter “duo mode”).

One of the objects of the invention is to allow the use of a single loudspeaker enclosure or of two loudspeaker enclosures in either mode, indifferently, with the same model of loudspeaker enclosure, by simply modifying a parameter of configuration of the internal processing executed by algorithms implanted in a digital signal processor.

Moreover, in the case of two loudspeaker enclosures (duo mode), the problem is posed of the width of the sound scene, delimited by the position of the loudspeaker enclosures that are not always as spaced apart as that would be desirable for a good rendering of the stereo image.

Another object of the invention is, in such a duo mode configuration, to further enlarge the sound scene rendered, by using the space located beyond the loudspeaker enclosures (on the left of the left loudspeaker enclosure and on the right of the right loudspeaker enclosure).

For that purpose, the invention proposes a multi-channel one-piece active acoustic loudspeaker enclosure of the general type disclosed in the above mentioned article of Schulman, i.e. comprising a central channel, with a central loudspeaker, the main axis of the own directivity diagram of which is oriented in a first direction, and side channels, respectively left and right, each with a side loudspeaker, the main axis of the own directivity diagram of which is oriented in a second direction, perpendicular to the first direction, in opposite directions for the left loudspeaker and for the right loudspeaker. Audio processing means receive as an input a composite stereo signal to be reproduced, including a left signal and a right signal, and distribute between the central channel and the side channels combinations of the left and right signals according to a predetermined distribution.

Characteristically of the invention, the audio processing means comprise separating means, operable to receive as an input the left and right signals of the composite stereo signal, and to extract therefrom at least one right or left side component based on an analysis in the frequency domain, with a comparison of the respective spectral energy levels of the left and right signals of the composite stereo signal. Combining means distribute between the central channel and the side channels combinations, according to a predetermined distribution, of signals including at least one of the right or left side components. Such combining means comprise filtering means operable to modify the directivity diagram rendered on each side channel so as to create thereon a direction of cancellation, with pressure-gradient filtering means receiving as an input at least one of the right or left side components.

The combining means may further apply a time delay to the signal, derived from the mono component, distributed to the central channel.

In a first operating mode, the loudspeaker enclosure is intended to be used alone in front of a listener, with the first direction directed toward this listener.

In this case, the separating means are operable to extract from the left and right signals of the composite stereo signal: a mono component, common to the left and right signals, a pure left side component and a pure right side component. The pressure-gradient filtering is a double pressure-gradient filtering receiving as an input either one of the pure left and right side components and delivering as an output both a left filtered signal and a right signal. The combining means are further operable to distribute: to the central channel, a signal derived from the mono component; to the left side channel, the left filtered signal; and to the right side channel, the right filtered signal.

The combining means may also distribute, to a deep-pitch channel with a non-directive bass loudspeaker, a signal derived from the mono component.

The angle of the cancellation direction with respect to the first direction is lower than 10°, preferably lower than 5°.

The pressure-gradient filtering is preferably applied only below a pivot frequency, so that the own directivity diagram of each side channel is kept above the pivot frequency. More precisely, the pressure-gradient filtering delivers as an output: to the left channel, a combination of a signal derived from the left side component with a signal derived from the right side component, with low-pass filtering below the pivot frequency and then application of a time delay and of an inversion; and to the right channel, a combination of a signal derived from the right side component with a signal derived from the left side component, with low-pass filtering below the pivot frequency and then application of a time delay and of an inversion. In a second operating mode, the loudspeaker enclosure is a first loudspeaker enclosure intended to be used in association with a second similar loudspeaker enclosure, the two loudspeaker enclosures being arranged on the left and on the right, respectively, of a listener.

In this case, for the loudspeaker enclosure intended to be placed on the left of the listener (and mutatis mutandis for that intended to be placed on the right of this same listener), the separating means extract from the left and right signals of the composite stereo signal a left surround component forming said left side component. The pressure-gradient filtering is a simple pressure-gradient filtering receiving as an input the left surround component, and delivering as an output both a left filtered signal and a right filtered signal. The combining means distribute: to the central channel, the left signal of the composite stereo signal; to the left side channel, the left filtered signal; and to the right side channel, the right filtered signal.

Advantageously, the combining means subtract the left surround component from the left signal distributed to the central channel.

The direction of cancellation of the right side channel is in particular a direction oriented toward said second similar loudspeaker enclosure, intended to be placed on the right of the listener.

The pressure-gradient filtering is preferably applied only below a pivot frequency, so that the own directivity diagram of each side channel is kept above the pivot frequency. More precisely, the pressure-gradient filtering is operable to deliver as an output: to the left channel, a signal directly derived from the left surround component; and to the right channel, a signal derived from the left surround component, with low-pass filtering below the pivot frequency and then application of a time delay and of an inversion.

An example of implementation of the device of the invention will now be described, with reference to the appended drawings in which same reference numbers designate identical or functionally similar elements throughout the figures.

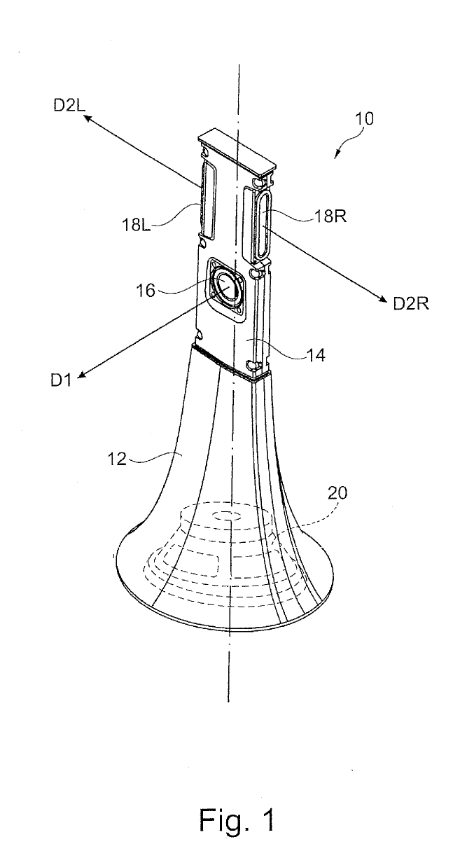

FIG. 1 is an isometric, perspective, overall view of a loudspeaker enclosure according to the invention, showing the acoustic architecture of the various loudspeakers used.

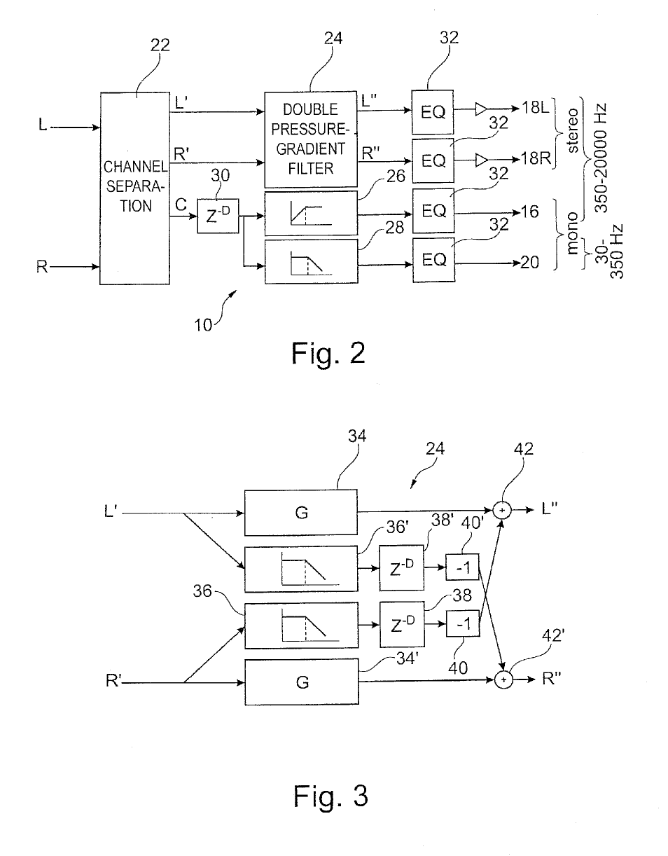

FIG. 2 illustrates, as a block diagram, the processing steps operated in a configuration with a single loudspeaker enclosure.

FIG. 3 describes in more detail the processing performed by the double pressure-gradient filter of FIG. 2.

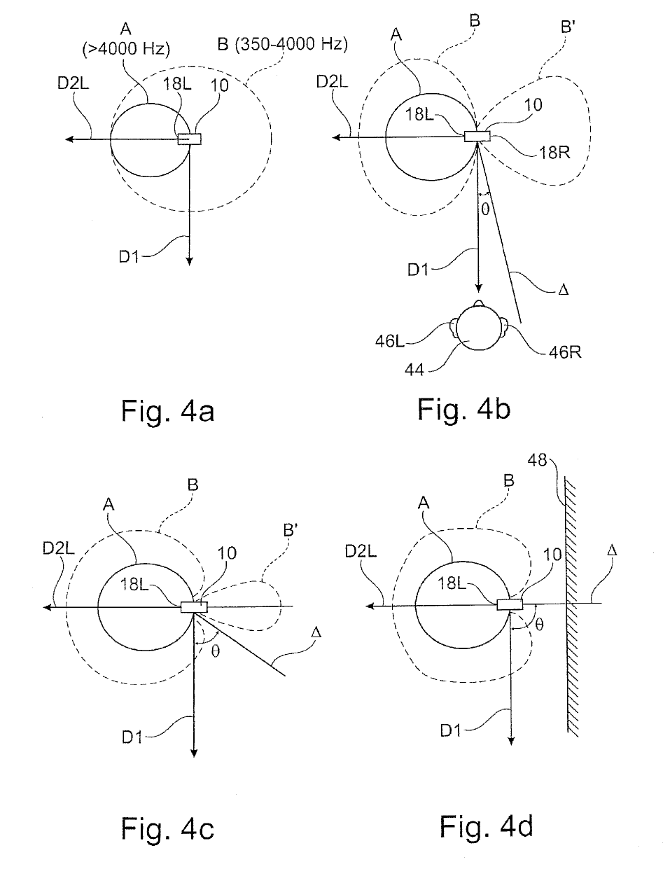

FIGS. 4a to 4d show different directivity diagrams that may be obtained from the loudspeaker enclosure for a side signal by modifying some parameters of the double pressure-gradient filter.

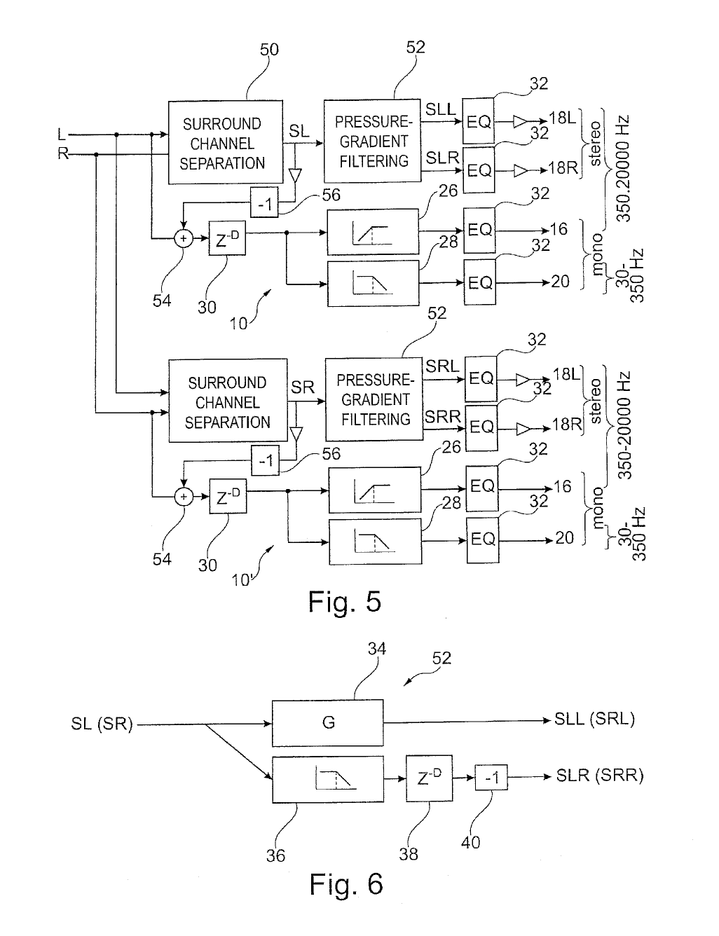

FIG. 5 illustrates, as a block diagram, the processing steps operated in a configuration with a pair of loudspeaker enclosures.

FIG. 6 illustrates in more detail the processing performed by the pressure-gradient filter of FIG. 5.

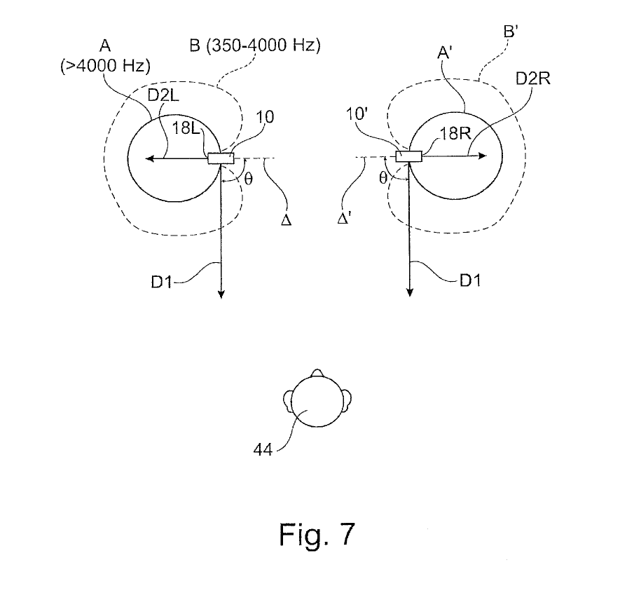

FIG. 7 illustrates an example of directivity diagram that may be obtained for the left loudspeaker enclosure and for the right loudspeaker enclosure, allowing an enlargement of the sound scene for the listener located in front of these two loudspeaker enclosures.

### GENERAL CONFIGURATION OF THE LOUDSPEAKER ENCLOSURE

FIG. 1 is an overall view of an loudspeaker enclosure according to the invention, showing the acoustic architecture of the various loudspeakers used.

The loudspeaker enclosure 10 is externally in the form of a column flaring at its lower portion, with a base 12 supporting a flatten-shaped elevated portion 14 having a section of the order of 3×12 cm.

The flatten elevated portion 14 carries a first loudspeaker 16 whose main direction of radiation D1 is horizontal and perpendicular to the greatest dimension of the rectangular section of the elevated portion 14. This loudspeaker 16 will be called hereinafter the “central loudspeaker”, corresponding to a “central channel” of the multi-channel loudspeaker enclosure.

The loudspeaker enclosure 10 also includes on the edge of the elevated portion 14, i.e. on the narrowest side face, a left loudspeaker 18L and a right loudspeaker 18R. These loudspeakers are oriented with their respective main directions of radiation D2L and D2R, horizontal and perpendicular with respect to the direction D1. These loudspeakers will be called hereinafter the “side loudspeakers”, corresponding to the left and right “side channels” of the multi-channel loudspeaker enclosure.

The central loudspeaker 16 is advantageously a loudspeaker combining a distributed-mode and a piston-mode operation, for example a BMR model of HiWave Technologies. The side loudspeakers 18L and 18R are advantageously distributed-mode loudspeakers with a high shape factor (i.e. with a very elongated and very narrow shape), for example HARP models of HiWave Technologies.

Essentially, in a loudspeaker of the distributed-mode or DML (Distributed Mode Loudspeaker) type, the flat diaphragm is put in vibration according to a complex diagram where the amplitude and the phase of the various points of the diaphragm are distributed in a decorrelated manner, i.e. the diaphragm seems to be put in vibration in a random manner over the extent of its surface, which allows obtaining an excellent acoustic rendering over the whole extent of the spectrum with a minimal distortion. On the other hand, in a conventional piston-mode operation, the membrane is subjected to a coherent vibration, i.e. a movement whose displacement amplitude and phase are in principle constant over the whole extent of the diaphragm.

The central loudspeaker 16 and the side loudspeakers 18L and 18R are used to render, together, the medium/high-pitch portion of the spectrum, for example the 350-2000 Hz band of the sound spectrum.

For the rendering of the low portion of the spectrum, for example of the 30-350 Hz band, a deep-pitch channel with a bass loudspeaker 20 is provided, which may be of the conventional piston type, for the reproduction of the deepest frequencies (subwoofer). This bass loudspeaker 20 is for example a loudspeaker mounted in closed cavity, turned toward the ground to radiate in the interval comprised between the base and the ground (the base being provided with feet), such configuration presenting no particular difficulty taking into account the very low directivity of the acoustic waves in the frequency band considered.

The acoustic architecture that have just been described with reference to this FIG. 1 will be used in combination with digital processing operations specific to each channel, such processing operations being different according to whether the loudspeaker enclosure is used in “solo” mode, with only one loudspeaker enclosure turned toward the listener, or in “duo” mode, with a pair of loudspeaker enclosures placed in front of the listener, on the left and on the right of the latter.

### “Solo” Operating Mode, with a Single Loudspeaker Enclosure

FIG. 2 illustrates, as a block diagram, the processing steps in the case of a single loudspeaker enclosure, used in solo mode.

It will be noted that, although this scheme is shown as interconnected circuits, the implementation of the various functions is essentially software-base, and this representation is given only by way of illustration. The software may in particular be implemented by calculation algorithms executed within a chip dedicated to the digital signal processing, of the DSP type, in an iterative manner, at the sampling frequency, for the successive signal frames.

On the other hand, here and in the following, only the processing aspects specific to the use in solo mode or in duo mode will be described. For the other, non-specific aspects of the loudspeaker enclosure, such as the description of the amplification, equalization chains, etc., reference will be made to the WO 2008/139047 A2 (Parrot), which describes an active acoustic loudspeaker enclosure such as that marketed under the name Zikmu by Parrot, Paris, France. The loudspeaker enclosure described in this document is a multi-channel active loudspeaker enclosure, in this case two channels supplied with a digitized audio signal, each having its own chain of power stages directly supplied with the corresponding frequency components of the digital signal to be reproduced, after filtering and processing by a DSP.

The first step consists in operating a separation of the channels or upmix, such technique, known in itself, consisting in separating the mono component C of the stereo components L′ and R′, from the composite input signal L, R, comprising the mono and stereo components mixed up together. This separation (block 22) implies an analysis of the signals L and R in the frequency, or time-frequency, domain, with comparison of the relative spectral energy levels between the signals L and R, and thresholding. That way, at a given instant, a same frequency can be on only one of the three channels L′, R′ or C. More precisely, at a given instant:
a frequency of same energy on the two channels L and R will be on the mono component C, whatever the phase thereof: there will thus be no mono in the stereo components L′ and R′, and
a pure frequency of higher energy on the channel L (respectively R) than on the channel R (respectively L) will be in the stereo component L′ (respectively R′) and will not be in the mono component C; their will thus be no stereo in the mono component C.

Insofar as, at a given instant, a same frequency can be on only one of the three channels L′, R′ or C, it is certain that there will be no acoustic intereactions other than those provided by the processing of the stereo, in particular that there cannot be interactions between the central loudspeaker 16, allotted to the reproduction of the mono component C, ant the side loudspeakers 18L and 18R, allotted to the reproduction of the stereo components L′ and R′. Any deformation of the mono component by the stereo components, which are subjected to a specific processing, which is proper to them, is thus avoided.

More precisely, the stereo components L′ and R′ obtained at the output of the separating stage 22 are subjected to a filtering by a stage 24 of the double pressure-gradient type (described in more detail with reference to FIG. 3), to give two corresponding filtered components L″ and R″ applied to the loudspeakers of the left and right channels 18L and 18R.

As for the mono component C, the latter is separated by a crossover filter 26, 28, separating the medium/high-pitch portion of the spectrum of the mono component C, to apply it to the central loudspeaker 16, and the bass portion of this same component C, to apply it to the loudspeaker of the deep-pitch channel 20.

To reinforce the stereo effect, it is possible to apply a delay (block 30) to the signal C delivered by the channel separation stage 22, to act on the “precedence effect”, such technique consisting in delaying the mono signal (central channel and bass channel) with respect to the stereo channels (side channels): the stereo components arriving in advance with respect to the mono component, the perception of the stereo being intensified.

The signals reproduced by the loudspeakers 16, 18L, 18R and 20 are each subjected to an equalization (blocks 32) with a linear filtering, to correct possible acoustic accidents of the loudspeakers and to apply a suitable relative gain to the different channels so as to increase or reduce the relative level thereof, in particular the level of the stereo signals reproduced by the side channels with respect to the central channel and to the bass channel, so as to compensate for the difference of sensitivity of the loudspeakers and/or to increase or reduce the stereo effect.

FIG. 3 explains the double pressure-gradient filtering operated by the block 24.

The matter is to combine the stereo components L′ and R′ to give new components L″ and R″ applied respectively to the left and right channels 18L and 18R.

The component L′ is applied to a direct filter 34 (simple gain stage). For its part, the left component R′ is applied to a low-pass filter 36 with a typical cut-off frequency of 4 kHz. The output signal of this filter 36 is subjected to an adjustable delay (block 38) and to an inversion (block 40), before being recombined at 42 to the output signal of the block 34, to give the filtered component L″ that, after amplification and equalization, will be reproduced by the left side loudspeaker 18L.

As for the right channel, the right loudspeaker 18R is supplied with a filtered stereo component R″ derived from the component R′ and L′ after processing by the stages 34′, 36′, 38′, 40′ and 42′ operating in the same way as the above-described stages 34 to 42.

The double pressure-gradient filtering processing (i.e. each of the filtered stereo component is derived from the two stereo components L′ and R′ applied at the input) allows modifying in a controlled manner, by adjustment of the delays 38, 38′, the directivity diagram of each of the side loudspeakers.

The double pressure-gradient filtering allows acting of the directivity diagram in such a manner to render optimally the stereo components for a listener located in front of the single loudspeaker enclosure, and for different configurations of listening room (the mono component C being rendered by the central loudspeaker 16 turned toward the listener, and by the subwoofer 20).

There have been illustrated in FIGS. 4a to 4d different directivity diagrams that may be obtained from a side loudspeaker, for example the left side loudspeaker 18L, by modifying some parameters of the double pressure-gradient filtering.

In the absence of any filtering, the directivity diagram of the left loudspeaker 18L is that illustrated in FIG. 4a, where it is noted that the loudspeaker is directive in the high-pitch portion of the spectrum (diagram A in full line, for the frequencies above 4000 Hz), and omnidirectional in the medium/deep-pitch portion (diagram B in dotted line, for frequencies in the 350-4000 Hz range).

It can be shown that, by adjusting the value of the delay applied by the block 38, and due to the inversion performed by the block 40, the directivity diagram produced by the combination L″ of the two right and left signals L′ and R′, for a signal played only on the left, corresponding to that illustrated in FIG. 4b: in the medium/deep-pitch range, the diagram comprises two side lobes B and B′ separated by a valley defining a direction of cancellation Δ. On the other hand, in the high-pitch range, typically beyond 4000 Hz, the low-pass filter 36 stops the signal, so that the double pressure-gradient filter has no specific actions in this region of the spectrum (the diagram A is not modified).

The angle θ between the direction of cancellation Δ and the axis D1 corresponding to the direction of the listener (direction perpendicular to the main direction D2L of the loudspeaker 18L) is given by the relation:

sin θ=c*D/a,

where a is the width of the loudspeaker enclosure (i.e. the spacing between the two loudspeakers 18L and 18R, typically of the order of 12 cm), c is the celerity of sound, and D is the delay introduced by the delay stage 38. This relation is true at a distance from the loudspeaker enclosure very higher than a, a condition that is always verified in practice, the listener being generally at several meters from the loudspeaker enclosure.

For a signal played on the right by the right loudspeaker 18R, the directivity diagram is of course symmetrical.

Having a direction of cancellation allows amplifying the stereo in various ways.

In the first case, illustrated in FIG. 4b, the angle θ is low, of the order of 3 to 4°, so that, if the listener 44 is in the main direction D1 of the loudspeaker enclosure, the direction of cancellation Δ for the left channel is in the vicinity of the right ear 46R of the listener, and, likewise, the direction of cancellation of the right channel is in the vicinity of the left ear 46L of the listener. Therefore, the left ear will pick up predominantly the stereo component L′, and the right ear predominantly the right component R′; the listener will hear distinctly the stereo information as if the loudspeakers were located on either side of his head.

This first case is particularly adapted to the situations where there is no acoustic reflections, or where these latter are symmetrical.

By increasing the delay, it is possible to move farther away the direction of cancellation Δ from the axis D1 (FIG. 4c), or even up to θ=90° (FIG. 4b): in this latter case, as illustrated, the diagram of radiation is then fully located on one side of the loudspeaker enclosure, the radiation being maximum on one side. This case is well adapted to the configurations presenting risks of important acoustic reflections on one of the sides of the loudspeaker enclosure 10, for example if the latter is placed in the vicinity of a wall 48 of the listening room.

### “Duo” Operating Mode, with a Pair of Loudspeaker Enclosures

FIGS. 5 to 7 illustrate the way the processing of the signal may be modified when the loudspeaker enclosure according to the invention is used with another similar loudspeaker enclosure, the pair of left 10 and right 10′ loudspeaker enclosures being arranged on either side of the listener 44 according to a conventional configuration (schematically illustrated in FIG. 7), where the two loudspeaker enclosures are arranged on the left and on the right, respectively, in front of the listener.

It will be noted that, in this case, the acoustic architecture illustrated in FIG. 1, i.e. the respective configuration of the different loudspeakers, is not modified, and that the operation in solo mode or in duo mode results only from a modification of the digital signal processing operated within the DSP.

The switching from one operating mode to the other will thus be extremely simple and will require no physical modification of the loudspeaker enclosure.

The processing applied in duo mode has for object to enrich the conventional stereo image formed between the two loudspeaker enclosures 10 and 10′, in particular by enlarging the sound scene (which is particularly advantageous when the two loudspeaker enclosures 10 and 10′ are placed relatively close to each other), and this without introducing distortion in the rendered signal, in particular without deteriorating the mono component.

By this configuration, the separation stage or upmix (block 50) operates an extraction of the surround channels, with a left surround component SL for the loudspeaker enclosure 10 placed on the left of the listener, and in the same way a right surround enclosure SR for the loudspeaker enclosure 10′ located on the right of the listener.

The surround components are obtained by analysis of the stereo content of the signals L, R applied at the input, to extract new signals containing the information very decorrelated between the left L and right R signals. There are in these surround components:
the pieces of information that have be mixed up very on the right or very of the left, as well as
reverberation, and
the pieces of “surround” information within the narrow meaning, for example the noise of the public in the case of a recording on stage.

These components are, as above, extracted by analysis in the frequency domain and comparison of the respective spectral energy levels of the signals L, R applied at the input.

For the loudspeaker enclosure 10, the surround signal SL (respectively SR) is applied to a simple pressure-gradient filtering stage 52, to give two filtered surround components SLL and SLR reproduced by the left loudspeaker 18L and by the right loudspeaker 18R, respectively, of this loudspeaker enclosure 10 (itself placed on the left of the listener).

Likewise, for the loudspeaker enclosure 10′, the right surround component SR is filtered to give two filtered components SRL and SRR reproduced by the left loudspeaker 18L and by the right loudspeaker 18R, respectively, of this loudspeaker enclosure 10′ (itself placed on the right of the listener). For the loudspeaker enclosure 10, the central channel of the loudspeaker 16 is supplied with a component coming from the left signal L from which has been subtracted, by the blocks 54 and 56, the surround compound SL. Likewise, for the loudspeaker enclosure 10′, the central channel of the loudspeaker 16 is supplied with a component coming from the right signal R from which has been subtracted, by the blocks 54 and 56, the surround component SR.

Therefore, the surround components are reproduced by the side channels (loudspeakers 18L and 18R), whereas the components of the stereo signal that are not surround components are reproduced by the central channel (loudspeaker 16), in a conventional manner but without interference between the surround components of the signal and the components of this signal that are not surround components.

As in the solo mode, in order to reinforce the stereo, it is possible to act on the precedence effect by delaying the left (respectively right) channel with respect to the left (respectively right) surround channels, by means of the delays introduced by the blocks 30: the surround components arriving in advance with respect to the standard stereo components, the perception of the surround can thus be intensified.

The linear filtering stages 32 allowing, if need be, to correct the acoustic accidents of the different loudspeakers and to increase or reduce the level of the stereo side channels with respect to the mono central channel and to the mono bass channel, to compensate for the difference of sensitivity of the loudspeakers and to increase or reduce the stereo effect.

FIG. 6 illustrates in more detail the processing performed by the (simple) pressure-gradient filter 52.

The latter includes a direct filter 34, i.e. a simple gain stage, which delivers the SLL component filtered from the surround component SL applied at the input (respectively, the component SRL filtered from the component SR applied at the input). As for the component SLR (respectively SRR), it results from the application of the surround component SL (respectively SR) to the low-pass filter 36, then to the delay stage 38 and to the inversion stage 40.

The operation of the stages 34, 36, 38 and 40 is the same as that which has been exposed with reference to FIG. 3 for the solo mode, the only difference being that here the filter is a single-input filter.

By adjusting the value of the delay D applied by the block 38, and thanks to the inversion by the block 40, it can be shown that the directivity diagram of a surround signal on the loudspeaker enclosure 10 placed at the left of the listener 44 is comparable to that illustrated in FIGS. 4b to 4d hereinabove, with a direction of cancellation Δ forming with the main direction D1 of the loudspeaker enclosure an angle θ determined by the relation sin θ=c*D/a, in the same manner as what has been exposed hereinabove relating to the solo mode.

As illustrated in FIG. 7, in the duo mode, it is particularly advantageous to give to the angle θ a value of 90°, so that the direction of cancellation Δ of the diagram B of the loudspeaker enclosure 10 arranged on the left is turned to the right toward the loudspeaker enclosure 10′ arranged on the right of the listener, and that, in the same manner, the direction of cancellation Δ′ of the diagram B′ of the loudspeaker enclosure 10′ arranged on the right is turned to the left toward the loudspeaker enclosure 10 arranged on the left of the listener.

The radiation diagrams of the surround compound in the deep/medium-pitch range (A or A′) or in the high-pitch range (B or B′) will then be located fully on one side of the loudspeaker enclosure, with a maximum radiation beyond the area where are located the two loudspeaker enclosures, thus allowing enlarging the sound scene by rendering content beyond this area. Finally, in order to adapt to the case where a wall would be on the side of a loudspeaker enclosure, it is possible to adjust the level of the surround signals to reduce the reverberation effect resulting from this proximity.

1. A multi-channel one-piece active acoustic loudspeaker enclosure (10, 10′), comprising:
a central channel, with a central loudspeaker (16), the main axis of the own directivity diagram of which is oriented in a first direction (D1);
side channels, respectively left and right, each with a side loudspeaker (18L, 18R), the main axis of the own directivity diagram of which is oriented in a second direction (D2L, D2R), perpendicular to the first direction, in opposite directions for the left loudspeaker and for the right loudspeaker; and
audio processing means, operable to receive as an input a composite stereo signal to be reproduced, including a left signal (L) and a right signal (R), and to distribute between the central channel and the side channels of the combinations of the left and right signals (L, R) according to a predetermined distribution,
characterized in that the audio processing means comprise:
separating means (22; 50), operable to receive as an input the left and right signals (L, R) of the composite stereo signal, and to extract therefrom at least one right (R′; SR) or left (L′; SL) side component based on an analysis in the frequency domain, with a comparison of the respective spectral energy levels of the left and right (L, R) signals of the composite stereo signal;
combining means (24, 52, 26, 28) operable to distribute between the central channel and the side channels combinations, according to a predetermined distribution, of signals including at least one of the right (R′; SR) or left (L′; SL) side components,
said combining means comprising filtering means operable to modify the directivity diagram (B, B′) rendered on each side channel so as to create thereon a direction of cancellation (Δ, Δ′),
said filtering means being pressure-gradient filtering means receiving as an input at least one of the right (R′; SR) or left (L′; SL) side components.

2. The active acoustic loudspeaker enclosure of claim 1, in which the combining means are further adapted to apply a time delay (30) to the signal, derived from the mono component (C), distributed to the central channel.

3. The active acoustic loudspeaker enclosure of claim 1, for use in a first operating mode in which said loudspeaker enclosure (10) is intended to be used alone in front of a listener (44) with the first direction (D1) directed toward said listener,
said loudspeaker enclosure (10) being characterized in that:
the separating means (22) are operable to extract from the left and right signals (L, R) of the composite stereo signal: a mono component (C), common to the left and right signals, a pure left side component (L′) and a pure right side component (R′);
the pressure-gradient filtering is a double pressure-gradient filtering receiving as an input either one of the pure left (L′) and right (R′) side components and delivering as an output both a left filtered signal (L″) and a right signal (R″); and
the combining means (24, 26, 28) are further operable to distribute:
to the central channel, a signal derived from the mono component (C);
to the left side channel, the left filtered signal (L″); and
to the right side channel, the right filtered signal (R″).

4. The active acoustic loudspeaker enclosure of claim 3, further comprising a deep-pitch channel with a non-directive bass loudspeaker (20), and wherein the combining means are operable to distribute to this deep-pitch channel a signal derived from the mono component (C).

5. The active acoustic loudspeaker enclosure of claim 3, wherein the angle (θ) of the cancellation direction with respect to the first direction (D1) is lower than 10°, preferably lower than 5°.

6. The active acoustic loudspeaker enclosure of claim 3, wherein the pressure-gradient filtering is a filtering applied only below a pivot frequency, so that the own directivity diagram (A) of each side channel is kept above the pivot frequency.

7. The active acoustic loudspeaker enclosure of claim 6, wherein the pressure-gradient filtering (24) is a filtering operable to deliver as an output:
to the left channel, a combination (L″):
of a signal derived from the left side component (L′), with
a signal derived from the right side component (R′), with low-pass filtering (36) below the pivot frequency and then application of a time delay (38) and of an inversion (40), and
to the right channel, a combination (R″):
of a signal derived from the right side component (R′), with
a signal derived from the left side component (L′), with low-pass filtering (36′) below the pivot frequency and then application of a time delay (38′) and of an inversion (40′).

8. The active acoustic loudspeaker enclosure of claim 1, for use in a second operating mode in which said loudspeaker enclosure (10) is intended to be used as a loudspeaker enclosure placed on the left, or respectively on the right, of a listener (44) in association with a second similar loudspeaker enclosure (10′), intended to be placed on the right, or respectively on the left, of this same listener (44),
said loudspeaker enclosure (10) being characterized in that:
the separating means (22) are operable to extract from the left and right signals (L, R) of the composite stereo signal a left surround component (SL) forming said left side component, or respectively a right surround component (SR) forming said right side component;
the pressure-gradient filtering is a simple pressure-gradient filtering receiving as an input the left (SL), or respectively right (SR), surround component, and delivering as an output both a left filtered signal (SLL; SRL) and a right filtered signal (SLR; SRR); and
the combining means (24, 26, 28) are further operable to distribute:
to the central channel, the left (L), or respectively right (R), signal of the composite stereo signal, and
to the left side channel, the left filtered signal (SLL; SRL); and
to the right side channel, the right filtered signal (SLR; SRR).

9. The active acoustic loudspeaker enclosure of claim 8, wherein:
the combining means are further operable to subtract the left surround component (SL) from the left signal (L) distributed to the central, or respectively the right surround component (SR) of the right signal (R) distributed to the central channel.

10. The active acoustic loudspeaker enclosure of claim 8, wherein the direction of cancellation of the right side channel (Δ), respectively of the left side channel (Δ′), is a direction oriented toward said second similar loudspeaker enclosure (10′), intended to be placed on the right, or respectively on the left, of the listener (44).

11. The active acoustic loudspeaker enclosure of claim 8, wherein the pressure-gradient filtering is a filtering applied only below a pivot frequency, so that the own directivity diagram (A) of each side channel is kept above the pivot frequency.

12. The active acoustic loudspeaker enclosure of claim 11, wherein the pressure-gradient filtering (52) is a filtering operable to deliver as an output:
to the left channel, a signal (SLL) directly derived from the left surround component (SL); and
to the right channel, a signal (SLR) derived from the left surround component (SL), with low-pass filtering (36) below the pivot frequency and then application of a time delay (38) and of an inversion (40),
or, respectively:
to the right channel, a signal (SRR) directly derived from the right surround component (SR); and
to the left channel, a signal (SRL) derived from the right surround component (SR), with low-pass filtering (36) below the pivot frequency and then application of a time delay (38) and of an inversion (40).
